(19) United States
(12) Patent Application Publication
(10) Pub. No.: US 2017/0147129 A1
(43) Pub. Date: May 25, 2017

(54) USER TERMINAL DEVICE AND METHOD FOR CONTROLLING SAME

(71) Applicant: Samsung Electronics Co., Ltd., Suwon-si (KR)

(72) Inventors: Jae-ki KYOUN, Yongin-si (KR); Chang-seog KO, Hwaseong-si (KR); Joon-ho PHANG, Seoul (KR); Kwan-min LEE, Seoul (KR)

(73) Assignee: SAMSUNG ELECTRONICS CO., LTD., Suwon-si (KR)

(21) Appl. No.: 15/319,252

(22) PCT Filed: Apr. 29, 2015
(86) PCT No.: PCT/KR2015/004330

§ 371 Date: Dec. 15, 2016

(30) Foreign Application Priority Data
Jun. 17, 2014 (KR) 10-2014-0073744

(51) Int. Cl. G06F 3/041; H04W 4/00; H04N 21/4402

(52) U.S. Cl. CPC G06F 3/0416; H04N 21/4402; H04W 4/008

(57) ABSTRACT

A user terminal device is disclosed. The user terminal device includes a communicator configured to perform communication with an external electronic device, a display device configured to display a screen, a user interface configured to receive an input of a touch interaction to the screen, and a controller configured to share a content with an external electronic device previously mapped in a finger movement direction of the touch interaction, in accordance with the finger movement direction.

### FIELD OF THE INVENTION

The present disclosure relates to a user terminal device and a control method thereof, and more particularly, to a touch-based user terminal device and a control method thereof.

### DESCRIPTION OF THE RELATED ART

Accompanied with the advanced electronic technologies, display devices are developed in a variety of types. Specifically, the display device such as TV, PC, laptop computer, tablet PC, mobile phone, MP3 player, and so on are widely distributed such that these are used in most of households.

Recently, in order to satisfy the user's needs for newer and more diverse functions, attempts are being made to develop a newer form of display device. For example, a second device, synchronized with TV, provides various information associated with the content provided by the TV.

Accordingly, a method is necessary, which can allow utilization of the content provided by the TV and the second device in more diverse manners.

### DETAILED DESCRIPTION

### Technical problem

The present disclosure is made to meet the needs mentioned above, and accordingly, it is an object of the present disclosure to provide a user terminal device and a control method thereof, which are capable of allow content sharing with an external device by a simple touch interaction.

### Solution to the Problem

In order to achieve the object mentioned above, a user terminal device according to an exemplary embodiment of the present disclosure includes a communicator configured to perform communication with an external electronic device, a display device configured to display a screen, a user interface configured to receive an input of a touch interaction to the screen, and a controller configured to share a content with an external electronic device previously mapped in a finger movement direction of the touch interaction, in accordance with the finger movement direction.

Further, the controller may transmit the content displayed on the screen to the external electronic device previously mapped in the finger movement direction and may share the content displayed on the screen with the external electronic device.

Further, when the external electronic device is in turn-off state, the controller may transmit a control signal to turn-on the external electronic device to the external electronic device.

Further, when the content displayed on the screen is transmitted to the external electronic device and displayed, the controller may provide associated information of the transmitted content on the screen.

Further, the controller may control such that the content displayed on the screen and the content transmitted to the external electronic device and displayed are seamlessly connected according to the dragging direction and displayed.

Further, the controller may receive the content displayed on the screen from the external electronic device previously mapped in the dragging direction of the touch interaction, and may share the content with the external electronic device.

Further, when the touch interaction is an interaction of dragging in an upward direction of the screen, the controller may transmit the displayed content to the external electronic device, and when the touch interaction is an interaction of dragging in a downward direction of the screen, the controller may receive the displayed content from the external electronic device.

Further, when the touch interaction is an interaction of dragging to one of leftward and rightward directions of the screen, the controller may transmit the displayed content to an SNS server.

Further, when the touch interaction is an interaction of dragging to one of leftward and rightward directions of the screen, the controller may store the displayed content to a previously defined storage region.

Further, the control may enter a content sharing mode in response to a preset touch interaction to one region on the screen, reduce the screen and display the same.

Further, the controller may divide an outer region of the reduced screen into a plurality of regions, and provide information about an external electronic device corresponding to each of the divided regions.

Further, in response to a user interaction of touching the information about the external electronic device provided in each of the divided regions and dragging to a center region of the screen, the controller may receive the content displayed on a corresponding external electronic device and display the received content.

Further, in response to a user interaction of touching a center region of the screen and dragging to a region where the information about the external electronic device provided in each of the divided regions is displayed, the controller may transmit the content displayed on the screen to the corresponding external electronic device.

Further, the user terminal device may control such that a content receiving device is turned on, or a content transmitting device is turned off, in accordance with a dragging direction of the touch interaction.

Meanwhile, according to an embodiment of the present disclosure, a control method of a user terminal device includes performing communication with an external electronic device, inputting a touch interaction to a screen, and in accordance with a finger movement direction of the touch interaction, sharing the content with an external electronic device previously mapped in the finger movement direction.

Further, the step of sharing the content may transmit the content displayed on the screen to the external electronic device previously mapped in the finger movement direction and share the content displayed on the screen with the external electronic device.

Further, when the external electronic device is being in turn-off state, the step of sharing the content may transmit a control signal to turn-on the external electronic device to the external electronic device.

Further, the control method of the user terminal device may additionally include a step of, when the content displayed on the screen is transmitted to the external electronic device and displayed, providing associated information of the content transmitted onto the screen.

Further, the step of sharing the content may allow the content displayed on the screen, and the content transmitted to the external electronic device and displayed to be seamlessly connected according to the dragging direction, and displayed.

Further, the step sharing the content may receive the content displayed on the screen from the external electronic device previously mapped in the dragging direction of the touch interaction, and share the content with the external electronic device.

Further, the step of sharing the content may transmit the displayed content to the external electronic device when the touch interaction is an interaction of dragging in the upward direction of the screen, and receive the displayed content from the external electronic device when the touch interaction is an interaction of dragging in the downward direction of the screen.

Further, the step of sharing the content may transit the displayed content to SNS server, when the touch interaction is an interaction of dragging to one of leftward and rightward directions of the screen.

Further, the method may additionally include a step of entering the content sharing mode, reducing the screen, and displaying the same, in response to a preset touch interaction with respect to one region on the screen.

Further, in the step of reducing the screen and displaying the same, the outer region of the reduced screen may be divided into a plurality of regions, and each of the divided regions may provide the corresponding information about the external electronic device.

Further, in response to a user interaction of touching the information about the external electronic device provided in each of the divided regions, and dragging it to the center region of the screen, the step of sharing the content may receive the content displayed on the corresponding external electronic device and display the same, and in response to a user interaction of touching the center region of the screen and dragging to the region where the information about the external electronic device provided in each of the divided region is displayed, may transmit the content displayed on the screen to the corresponding external electronic device.

### Effects

According to various embodiments of the present disclosure described above, content can be shared in a variety of manners just with a simple user interaction manner. Accordingly, user convenience is improved.

### BRIEF DESCRIPTION OF THE DRAWINGS

FIG. 1 is a view provided to describe a control system according to an embodiment of the present disclosure.

FIGS. 2a and 2b are block diagrams illustrating a configuration of a user terminal device according to an embodiment of the present disclosure.

FIG. 3 is a block diagram illustrating a configuration of a storage according to an embodiment of the present disclosure.

FIG. 4 is a block diagram illustrating a configuration of a display device according to an embodiment of the present disclosure.

FIGS. 5a and 5b, and 6a to 6c are views provided to describe a method of pairing a display device and a user terminal device according to an embodiment of the present disclosure.

FIGS. 7a to 7c, and 8a and 8b are views provided to describe a method of implementing a network topology according to an embodiment of the present disclosure.

FIGS. 9a and 9b are views provided to describe a control method of a user terminal device according to an embodiment of the present disclosure.

FIG. 10 is a view illustrates a content sharing mode according to an embodiment of the present disclosure provided for the purpose of explanation thereof.

FIGS. 11a and 11b are views provided to describe a control method of a user terminal device according to another embodiment of the present disclosure.

FIGS. 12a and 12b are views provided to describe a control method of a user terminal device according to another embodiment of the present disclosure.

FIG. 13 is a view provided to describe a control method of a user terminal device according to yet another embodiment of the present disclosure.

FIGS. 14a to 14c are views provided to describe a control method of a user terminal device according to yet another embodiment of the present disclosure.

FIGS. 15a and 15b are views provided to describe a control method of a user terminal device according to yet another embodiment of the present disclosure.

FIG. 16 is a flowchart provided to describe a control method of a user terminal device according to an embodiment of the present disclosure.

### BEST MODE

### Detailed Description of Exemplary Embodiments

### Mode for Embodying the Invention

Hereinbelow, the present disclosure will be described in detail with reference to the accompanied drawings.

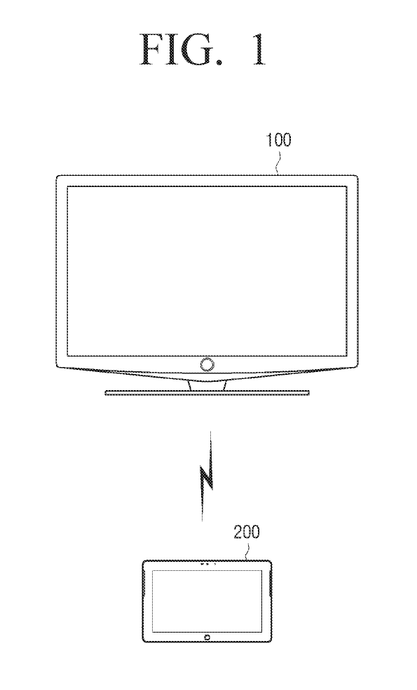

FIG. 1 is a view provided to describe a control system according to an embodiment of the present disclosure.

According to FIG. 1, a control system according to an embodiment of the present disclosure includes a user terminal device 100 and an electronic device 200.

As illustrated in FIG. 1, the electronic device 200 may be implemented as a digital TV, but not limited thereto. Accordingly, the electronic device 200 may be implemented as not only various forms of devices with display function such as a personal computer (PC), a navigation, a kiosk, a digital information display (DID), or a display attached to a home appliance such as a refrigerator, but also other various forms of devices not equipped with the display function, such as audio, air conditioner, lamp, and so on. Note that for the convenience of explanation, the electronic device 200 will be described below based on an assumption that it 200 is a display device.

The user terminal device 100 may be implemented such that it 100 performs communication with the display device 200 and can remotely control the display device 200. For example, the user terminal device 100 may perform a remote control function for the display device 200 while an application that provides remote control mode or remote control function is being driven. That is, in response to a user's instruction to control the display device 200, the user terminal device 100 may send a control signal corresponding to the inputted user instruction to the display device 200. Note that the embodiments are not limited to the example provided above, and accordingly, the user terminal device 100 may be implemented into various forms including, the user terminal device 100 sensing a motion of the user terminal device 100 and sending out a signal corresponding to the motion, perceiving a voice and sending out a signal corresponding to the perceived voice, sending a signal corresponding to an inputted key, and so on. In the examples mentioned above, the user terminal device 100 may be implemented to include a motion sensor, a touch sensor, or an optical Joystick sensor utilizing optical technology, a physical button (e.g., tact switch), a display screen, a microphone, and so on, in order to receive various forms of user instructions.

Further, the user terminal device 100 may sync with the information provided by the display device 200 and provide the same in real time basis. For example, the user terminal device 100 may provide a mirroring function that receives streams of the content displayed by the display device 200 and displays the same. In addition, the user terminal device 100 may be implemented to provide not only the remote control function, but also the original function of various terminal such as phone calling, internet function, photographing function, and so on.

Meanwhile, the user terminal device 100 may be implemented to share the content with various forms of external devices according to an interaction direction of touch interaction. Hereinbelow, a device control method according to various embodiments of the present disclosure will be described with reference to the drawings.

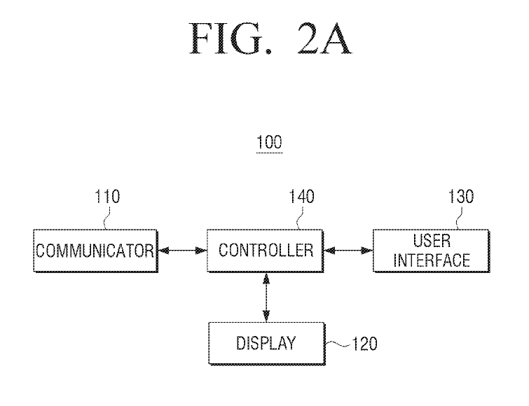

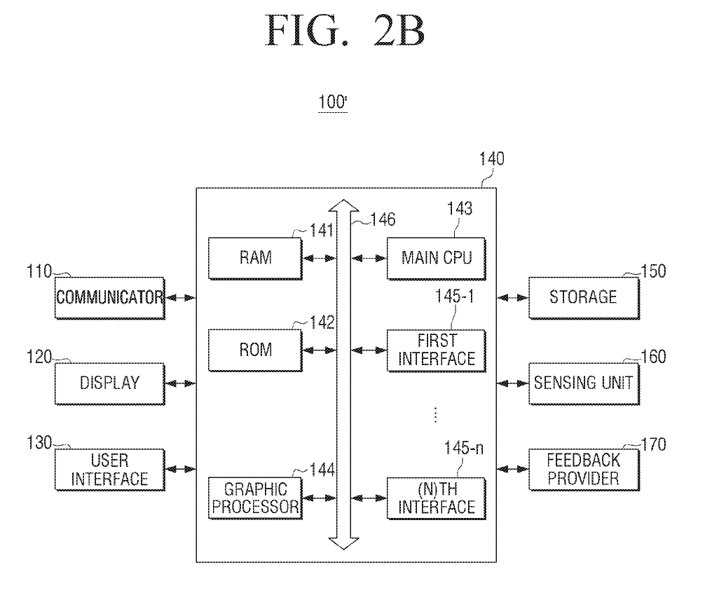

FIG. 2a is a block diagram illustrating a constitution of a user terminal device according to an embodiment of the present disclosure.

According to FIG. 2a, the user terminal device 100 includes a communicator 110, a display 120, a user interface 130, and a controller 140. The user terminal device 100 may be a portable terminal, or may be implemented to be various forms including tablet, mobile phone, PMP, PDA, and so on.

Specifically, the user terminal device 100 may be implemented to be a touch-based portable terminal that is equipped with a touch pad or a touch screen on a front side thereof. Accordingly, the user terminal device 100 may be implemented such that a touch sensor is embedded to enable a user to execute programs with a finger or a pen (e.g., stylus pen). To this purpose, the user terminal device 100 may be implemented to include a touch sensor or an optical joystick utilizing optical technology, in order to receive an input of various forms of user instructions.

<Interoperation between Electronic Device and User Terminal Device>

The communicator 110 performs communication with an external device according to various forms of communication methods.

Specifically, the communicator 110 may communicate with the display device 200 (see FIG. 1). The communicator 120 may communicate with the display device 200 or an external server (not illustrated) by a variety of communication techniques including BlueTooth (BT), Wireless Fidelity (WI-FI), Zigbee, infrared (IR), serial interface, universal serial bus (USB), near field communication (NFC), and so on.

To be specific, in response to occurrence of a preset event, the communicator 110 may enter into interoperation state by performing a communication with the display device 200 according to a previously defined communication method. The ‘interoperation’ as used herein may refer to all the state in which the communication is enabled, such as an operation of initializing communication between the user terminal device 100 and the display device 200, an operation of forming a network, an operation of performing device pairing, and so on. For example, device identification information of the user terminal device 100 may be provided to the display device 200, and the pairing process between the two devices may be performed accordingly. For example, in response to occurrence of a preset event at the user terminal device 100, the neighboring devices may be searched with the Digital Living Network Alliance technique and pairing may be performed with the searched device for interoperation.

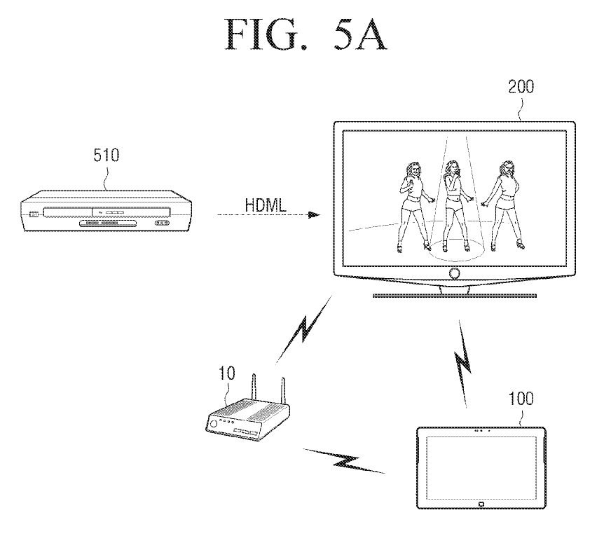

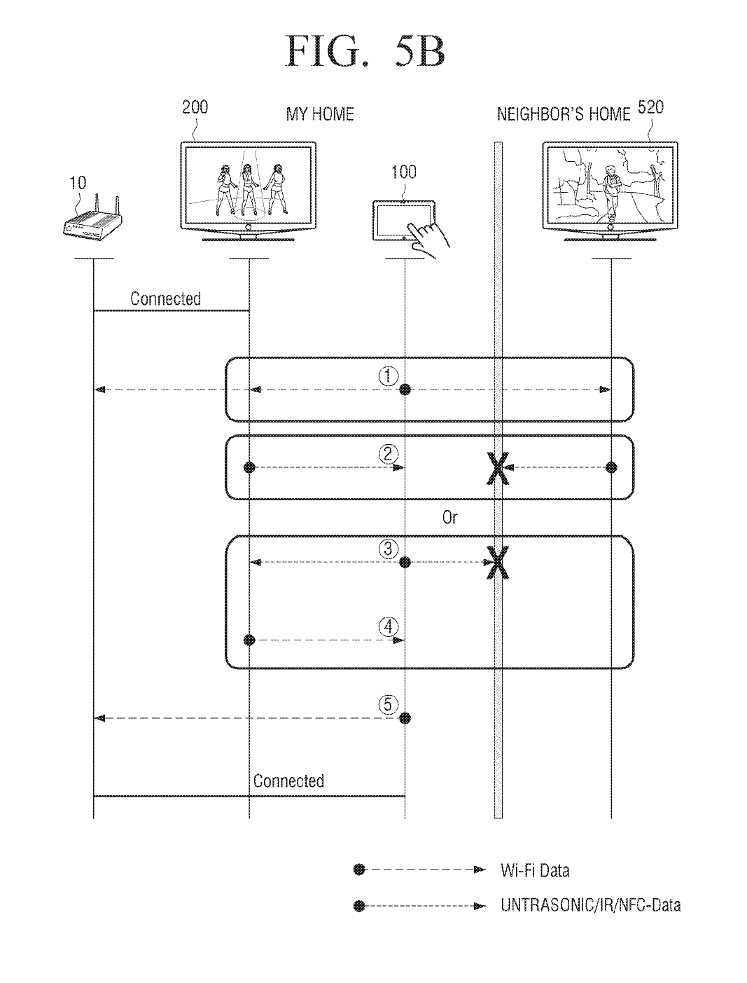

In one example, the preset event may occur at at least one of the user terminal 100 and the display device 200. For example, this may include an input of a user instruction from the user terminal device 100 to select the display device 200 to be a controlled device, or turning ON of at least one power of the user terminal device 100 and the display device 200. Meanwhile, a method of pairing the user terminal device 100 and the display device 200 according to an embodiment of the present disclosure will be described in greater detail with reference to FIGS. 5a and 5b.

### <Displayed Information>

The display 120 displays a variety of screens. The screen may include a screen playing a variety of contents such as image, video, text, music, and so on, an application executing screen including a variety of contents, a web browser screen, a graphic user interface (GUI) screen, and so on. For example, when the user terminal device 100 is implemented as a remote control device to control the display device 200, the display 120 may provide a variety of UI screens to control the functions of the electronic device 200.

In the example described above, the display 120 may be implemented as a liquid crystal display (LCD) panel, organic light emitting diodes (OLED), and so on, although not limited thereto. Further, depending on need, the display 120 may be implemented as a flexible display, a transparent display, and so on.

### <Touch Interaction for Content Sharing>

The user interface 130 receives a variety of user interactions.

Specifically, the user interface 130 may be implemented as a form that includes a touch pad or a touch screen to receive an input of user's touch interactions. The ‘touch interaction’ as used herein may be a user interaction to control at least one of the user terminal device 100 and the display device 200.

Further, the user interface 130 may receive user interactions regarding various UI screens provided through the touch screen. The UI screen herein may include a screen to play various contents such as images, videos, texts, music, and so on, a screen to execute application including various contents, a web browser screen, and graphic user interface (GUI) screen, and so on.

Specifically, the user interface 130 may receive an input of a touch interaction to share the content displayed on the display 120 and/or the content displayed on the external display device 200. In this example, the touch interaction may be implemented as a variety of touching manners that can sense directions, such as touch-and-drag, touch-and-flick, touch-and-swiping, and so on. Note that an example of touch-and-drag manner will be described below for convenience of explanation. Meanwhile, a method of sharing content according to a touch interaction will be described in detail below based on the description about the controller 140.

The controller 140 controls the overall operations of the user terminal device 100.

### <Entering Content Sharing Mode>

The controller 140 may enter a content sharing mode according to a preset event. The ‘preset event’ as used herein may be an event of inputting a user interaction of pressing an arbitrary region on a screen (e.g., pressing for a preset time or longer), but not limited thereto.

The controller 140 may control such that, according to a finger movement direction of a touch interaction in the content sharing mode, at least one of the information on the external electronic device and content previously mapped in the moving direction, and the information on the content is shared. That is, an external device including a server may be previously mapped in a finger movement direction of the touch interaction or a drag region according to the finger movement direction. Note that, depending on circumstances, a specific service function may be mapped, as well as the external device. The ‘touch interaction’ as used herein may be implemented as a variety of forms including drag, flick, and so on, but for convenience of explanation, it is assumed below that the touch interaction is implemented as a drag form.

Specifically, the controller 140 may transmit the content displayed on the screen to the external electronic device that is previously mapped in the dragging direction of the touch interaction and may thus share the content displayed on the screen. For example, in response to a touch interaction of dragging in an upward direction of the screen, the content displayed through the external display device 200 may be transmitted.

Further, the controller 140 may transmit the information on the content displayed on the screen, for example, detailed information of the content, information of the channel that provides the content, source information (e.g., information on the device storing the content), and so on to the external electronic device previously mapped in the dragging direction of the touch interaction, and may thus share the information on the content displayed on the screen. In this example, the external electronic device may directly access the content source and download the content, or receive the streams, based on the corresponding information.

Further, the controller 140 may receive at least one of the content and the information on the content from the external electronic device previously mapped in the dragging direction of the touch interaction and share the content with the external electronic device. For example, in response to an input of the touch interaction of dragging in a downward direction of the screen, the content displayed on the screen and the information on the content may be received from the external electronic device. In response to receiving the information on the content from the external electronic device, the controller 140 may directly access the content source and download the content, or receive streams, based on the received information on the content.

Further, the controller 140 may share at least one of the content displayed on the screen and the information on the content, with the external server previously mapped in the dragging direction of the touch interaction. For example, in response to receiving a touch interaction of dragging to one of left-side and right-side directions of the screen, the displayed content may be uploaded to an SNS server. In this example, an image of capturing the displayed content may be transmitted, or the displayed content itself (e.g., video) may be uploaded to the SNS server.

Further, the controller 140 may store at least one of the content and the information on the content, on a previously defined storage region that is previously mapped in the dragging direction of the touch interaction. For example, in response to input of a touch interaction of dragging to one of the left-side and the right-side directions of the screen, the corresponding content may be stored in the favorite region, that is, the content may be stored as the favorite content.

Meanwhile, the controller 140 may provide a corresponding UI screen in the content sharing mode.

Specifically, while the content is being displayed on the entire region on the screen, when entering into the content sharing mode according to a preset event, the controller may reduce the content display screen and provide the same. The ‘preset event’ as used herein may be an event of inputting a user interaction of pressing an arbitrary region on the screen (e.g., pressing for a preset time or longer), but not limited thereto.

Further, the controller 140 may divide an outer region of the reduced screen into a plurality of regions based on a dragging direction of the touch interaction, and provide the information on the external electronic device (including information on external server, service, and so on) corresponding to each of the divided regions.

In this example, in response to a user interaction of touching the information on the external electronic device provided to each of the divided regions and dragging it toward the screen center region, the controller 140 may receive the content displayed on a corresponding electronic device and display the same.

Further, in response to a user interaction of touching the screen center region and dragging it to a region where the information on the external electronic device provided on each of the divided region is being displayed, the controller 140 may transmit the content displayed on the screen to a corresponding external electronic device.

Further, in response to a user interaction of long-pressing a region on which thumbnails, video content, and so on displayed on one region on the screen is being displayed in response to a preset event, the controller 140 may enlarge the corresponding thumbnail, video content screen and display the same, and divide the outer region of the enlarged screen into a plurality of regions and provide the information on the external electronic device (including information on external server, service, and so on) corresponding to each of the divided region.

### <Controlling Power ON/OFF According to Content Sharing>

Meanwhile, the controller 140 may control the content-receiving device to turn ON or the content-transmitting device to turn OFF, according to a dragging direction of the touch interaction.

Specifically, in order to share the content displayed on the screen according to the dragging direction of the touch interaction with the external electronic device, when the external electronic device is in turn-off state, the controller 140 may transmit a control signal to turn-on the external electronic device to the external electronic device. Accordingly, it is possible to automatically turn on the electronic device in turn-off state with the content share instruction only, such that the transmitted content can be displayed on the screen.

Further, when the displayed content is transmitted to the external electronic device, the controller 140 may automatically turn off the screen of the display 120, or turn off the power of the user terminal device 100. For example, the conversion described above may be performed according to user setting.

### <Converting Screen According to Content Sharing>

Meanwhile, the controller 140 may control such that the content transmitted to the external electronic device and displayed according to a touch interaction, and the content displayed on the screen may be seamlessly connected and displayed. For example, while the content is being transmitted, the controller 140 may control such that a portion of the content screen is displayed on the external electronic device, and the rest is seamlessly connected on the screen of the user terminal device 100 to be displayed thereon.

Specifically, the controller 140 may move the screen in a slide form and display the same, based on an amount of dragging (or location of dragging) of the touch interaction. In this example, the controller 140 may provide the information on the amount of dragging of the touch interaction to the external electronic device, and the external electronic device may determine the region information displayed on the user terminal device 100 and display the rest content region based on the result of the determination. Alternatively, the controller 140 may transmit to the external electronic device the information on the image region being currently displayed on the screen according to an amount of dragging (or location of dragging). For example, the information on the proportion of the currently-displayed region may be transmitted.

Further, when the content displayed on the screen is transmitted to the external electronic device and displayed, the controller 140 may perform the screen conversion with respect to the screen of the display 120.

Specifically, when the content displayed on the screen is transmitted to the external electronic device, the controller 140 may provide the information associated with the transmitted content onto the screen. For example, when the transmitted content is sports broadcast image, the sports broadcast information may be provided on the screen. The ‘associated information’ as used herein may include a variety of information including various associated information provided by the TV networks, social feeds, content detailed information, and so on, and may be updated on real-time basis.

In this example, the controller may receive the associated information through an external electronic device such as TV, but it is also possible that the controller 140 directly receives through the external server.

Further, when the content displayed on the screen is transmitted to the external electronic device, the controller 140 may perform a screen conversion by converting into a standby screen (or background screen), or displaying preset information, and so on. In this example, the information for constructing the background screen will be described below.

### <Provision of Shared Content>

Meanwhile, after the time point at which at least one of the content and information on the content is shared, a device receiving at least one of the content and the information on the content may receive the shared content from the content source (not illustrated), or receive the corresponding content from the content-transmitting device. For example, when the information about the broadcast content (e.g., channel information) displayed on the screen of the user terminal device 100 is shared with the external electronic device, the external electronic device may tune to a broadcast channel that provides the corresponding broadcast content based on the received channel information and continuously provide the corresponding content. Alternatively, when the VOD content displayed on the screen of user terminal device 100 is shared with the external electronic device, the external electronic device may receive streams on a real-time basis from the user terminal device 100 and continuously provide the corresponding content. Alternatively, when the source information on the VOD content displayed on the screen is shared with the external electronic device, the external electronic device may download the VOD content based on the received source information, or receive streams and continuously provide the corresponding content.

### <Background Mode>

Further, the controller 140 may sense presence of connection with a cradle that can mount/charge the user terminal device 100, and when sensing that the user terminal device 100 is connected to the cradle, may activate the background mode. In this case, the background mode may be activated upon sensing a connection to the cradle, regardless of whether the previous screen state of the user terminal device 100 is OFF state or activate state.

The controller 140 may provide widgets, idle applications, photos, animations, advertisement information, and so on, in the background mode.

Specifically, the controller 140 may provide video-based content advertisement information, TPO-based information, and so on in the background mode. The video-based content advertisement information may include information such as recommendation/strategic live broadcast advertisement, recommendation/strategic VOD preview, and so on, and the TPO-based information may include information such as time information, weather information, traffic information, news, and so on.

As described above, in the background mode, the content advertisement information such as the recommendation, strategic live advertisement, the VOD preview, and so on may be provided, to thus induce users to buy content.

Further, the controller 140 may change the content provided in the background mode and display the same, in response to a preset event. For example, when a preset time elapses, the controller 140 may automatically change the advertisement content and display the same, or in response to occurrence of an event such as message reception, notification reception, and so on, the controller 140 may change to the content of a corresponding event and display the same, or provide a reminder about the reception of the corresponding message or notification.

Meanwhile, when the user terminal device 100 is not connected to the cradle, the controller 140 may turn OFF the screen after applying Timeout, i.e., after a preset time elapses.

### <Entering Initial Screen>

While the user terminal device 100 is being connected to the cradle, the controller 140 may release the background mode and provide the initial screen, upon sensing a user's motion.

Specifically, in response to sensing approach of the user or perceiving a specific user motion, the controller 140 may provide the initial screen. Alternatively, in response to perceiving a grip action of the user, the controller 140 may display the initial screen.

For example, the controller 140 may display the initial screen upon sensing the user's approach through a proximity sensor, and so on.

For another example, in response to sensing the user touch through a touch sensor provided on at least one of both side surfaces and rear surface of the user terminal device 100, the controller 140 may perceive the presence of a grip action and display the initial screen.

For yet another example, in response to sensing at least one of rotation and tilting through at least one of the gyro sensor and the acceleration sensor provided in the user terminal device 100, the controller 140 may perceive a presence of the grip action and display the initial screen.

FIG. 2b is a block diagram illustrating a detailed configuration of the display device 200 according to another embodiment of the present disclosure. According to FIG. 2b, the display device 200 includes a communicator 110, a display 120, a user interface 130, a controller 140, a storage 150, a sensing unit 160, and a feedback provider 170. Among the elements illustrated in FIG. 2b, the elements overlapped with those illustrated in FIG. 2a will not be redundantly described in detail.

The controller 140 controls the overall operations of the display device 200 by using various programs stored in the storage 150.

Specifically, the controller 140 includes RAM 141, ROM 142, main CPU 143, graphic processor 144, first to (n)th interfaces 145-1 to 145-n, and bus 146.

The RAM 141, the ROM 142, the main CPU 143, the graphic processor 144, and the first to (n)th interfaces 145-1 to 145-n may be connected to one another through the bus 146.

The first to (n)th interfaces 145-1 to 145-n may be connected with the respective elements described above. One of the interfaces may become a network interface that is connected to an external device through a network.

The main CPU 143 accesses the storage 150 and performs booting using the O/S stored in the storage 150. The various operations are then performed using the respective programs, content, data stored in the storage 150.

The ROM 142 stores a set of instruction languages for the system booting. When power is supplied in response to input of turn-on instruction, according to the instruction stored in the ROM 142, the main CPU 143 copies the O/S stored in the storage 150 onto the RAM 141 and executes the O/S to thus boot the system. When the booting is completed, the main CPU 143 copies the respective application programs stored in the storage 150 onto the RAM 140 and executes the application program copied onto the RAM 141 to thus perform the respective operations.

The graphic processor 144 generates a screen including various objects such as icons, images, texts, and so on, using a calculator (not illustrated) and a renderer (not illustrated). The calculator (not illustrated) calculates attribute values such as coordinates at which the respective objects will be displayed, shapes, sizes, colors, and so on, according to a layout of the screen based on the received control instruction. The renderer (not illustrated) generates a screen in various layouts including the objects based on the attribute values calculated at the calculator (not illustrated). The screen generated at the renderer (not illustrated) is displayed within the display region of the display 120.

The storage 150 stores various data such as operating system (O/S) for driving the user terminal device 100, software module, various multimedia content, various applications, various contents inputted or set during execution of the application, and so on.

Specifically, the storage 150 may store the device information, server information, service information, and so on, that correspond to the dragging direction of the touch interaction.

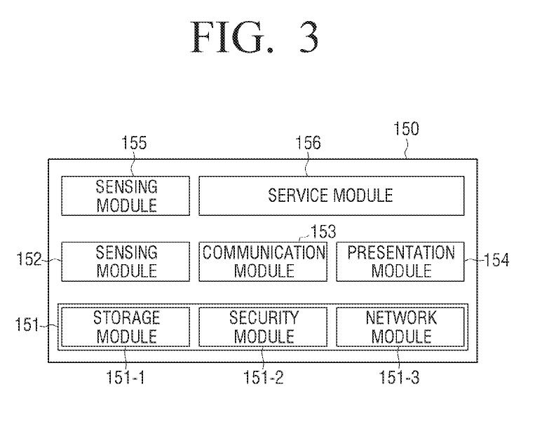

Various other software modules stored in the storage 150 will be described with reference to FIG. 3.

According to FIG. 3, the storage 150 may store software including a base module 151, a sensing module 152, a communication module 153, a presentation module 154, a web browser module 155, and a service module 156.

The base module 151 refers to a basic module that processes a signal delivered from each of the hardware included in the display device 100 and deliver it to an upper-layer module. The base module 151 includes a storage module 151-1, a security module 151-2, and a network module 151-3, and so on. The storage module 151-1 refers to a program module that manages the database (DB) or the registry. The main CPU 143 accesses the database within the storage 150 using the storage module 151-1 and retrieve various data. The security module 151-2 is a program module that supports certification, permission for request, secure storage, and so on for the hardware, and the network module 151-3 is a module to support the network connection and includes DNET module, UPnP module, and so on.

The sensing module 152 gathers information from the respective sensors, and analyzes and manages the gathered information. The sensing module 152 may include a touch recognition module, a head direction recognition module, a face recognition module, a voice recognition module, a motion recognition module, an NFC recognition module, and so on.

The communication module 153 is provided to perform communication with outside. The communication module 153 may include a device module for use in communication with an external device, a messaging module such as a messenger program, a short message service (SMS) & multimedia message service (MMS) program, an email program, and so on, and a telephone module including a call info aggregator program module, a VoIP module, and so on.

The presentation module 154 is provided to configure a display screen. The presentation module 154 includes a multimedia module to play back the multimedia content and output the same, and a UI rendering module to perform UI and graphic processing. The multimedia module may include a player module, a camcorder module, a sound processing module, and so on. Accordingly, an operation of generating screen and sound and playing the same by playing back various multimedia content is performed. The UI rendering module may include an image compositor module that combines images, a coordinate combining module that generates by combining the coordinates on the screen to display the image, an X11 module that receives various events from the hardware, a 2D/3D UI toolkit that provides a tool to configure 2D or 3D UI, and so on.

The web browser module 155 refers to a module that access a web server by performing web browsing. The web browser module 155 may include a variety of modules such as a web view module for configuring a webpage, a download agent module for performing download, a bookmark module, a web kit module, and so on.

The service module 156 is a module that includes various applications to provide a variety of services. Specifically, the service module 156 may include SNS program, content play program, game program, e-book program, calendar program, alarm management program, other widgets, and so on.

The sensing unit 160 includes a touch sensor, a geomagnetic sensor, a gyro sensor, an acceleration sensor a proximity sensor, a grip sensor, and so on. The sensing unit 160 may sense a variety of actions other than the touch interactions described above, such as approaching (or moving closer), grip, rotating, tilting, pressure, and so on.

The touch sensor may be implemented to be capacitive type or resistive type. The capacitive type touch sensor refers to a type of sensor that senses micro electricity excited in the body of a user upon a part of the user's body touching a surface of the display, by using a dielectric material coated on the surface of the display, and calculate the touch coordinates. The resistive type touch sensor includes two electrode plates embedded in the user terminal device 100′ such that upon user's touching, the touch sensors senses when the upper and lower plates at a point of touch are brought into contact and the current flows, to thus calculate the touch coordinates. In addition, the touch interaction may be sensed using infrared sensing method, surface ultrasonic conductance method, integral type tension measuring method, piezo effect method, and so on.

In addition, the user terminal device 100′ may determine whether a touch object such as a finger or a stylus pen is in contact or proximity, using a magnetic and a magnetic sensor, an optical sensor or a proximate sensor, instead of the touch sensor.

The proximity sensor is a sensor provided to sense an approaching motion without directly contacting the surface of the display. The proximity sensor may be implemented as various forms of sensors including a high frequency oscillation type that forms a high frequency magnetic field and senses electric current induced by the magnetic field characteristic that changes upon approaching of an object, a magnetic type that utilizes magnets, a capacitive type that senses capacitance that varies according to approaching of an object.

The grip sensor may be disposed on the rear surface, edge, and handle portion, separately from the touch sensor provided on the touch screen, to sense the user's grip. The grip sensor may be implemented as a pressure sensor, instead of the touch sensor.

The feedback provider 170 provides a variety of feedbacks with respect to a touch interaction.

Specifically, the feedback provider 170 may provide a haptic feedback and by the ‘haptic feedback,’ it refers to a technology that enables a user to feel tactile sensation by generating vibration or force, or impact on the user terminal device 100. This is also called the computer tactile technology.

Specifically, the feedback provider 170 may provide a variety of feedbacks by differently applying vibration conditions (e.g., vibration frequency, vibration length, vibration intensity, vibration waveform, vibration location, and so on) according to a touch dragging direction as perceived at the sensing unit 160. The method of generating a variety of haptic feedbacks by differently applying vibration method is already known and therefore, will not be redundantly described herein.

Meanwhile, in the embodiments described above, the feedback provider 170 is described as providing haptic feedbacks using vibration sensor, but this is provided only for illustrative purpose. Accordingly, the haptic feedbacks may also be provided by using a piezo sensor.

In addition, the feedback provider 170 may also provide a feedback in a form of sound, visual form, and so on, according to a dragging direction of the touch interaction. For example, the feedback provider 170 may provide a visual feedback corresponding to a trajectory of the touch interaction.

In addition, the user terminal device 100′ may further include an audio processor (not illustrated) configured to process audio data, a video processor (not illustrated) configured to process video data, a speaker (not illustrated) configured to output not only the respective audio data processed at the audio processor (not illustrated), but also various alarm sounds or voice messages, and a microphone (not illustrated) configured to receive user's voices or other sounds and convert these into audio data.

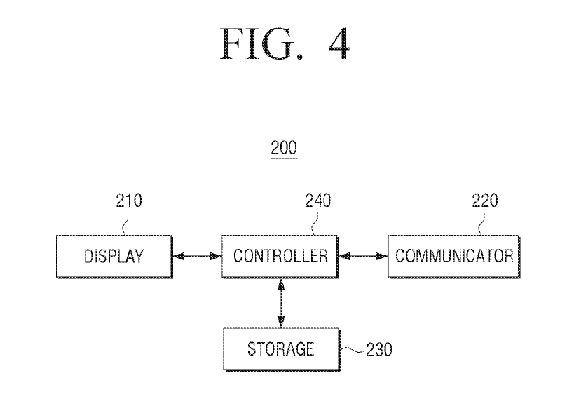

FIG. 4 is a block diagram illustrating a configuration of a display device according to an embodiment of the present disclosure.

As illustrated in FIG. 1, the display device 200 may be implemented as a digital TV, but not limited thereto. Accordingly, any remote-controllable device equipped with a display function, such as personal computer (PC), navigation, kiosk, digital information display (DID), and so on, may be non-limitedly applied.

The display 210 displays a variety of screens. The screen herein may include a screen playing a variety of contents such as images, videos, texts, music, and so on, a screen executing an application including a variety of contents, a web browser screen, a graphic user interface (GUI) screen, and so on.

In this example, the display 210 may be implemented as a liquid crystal display panel (LCD), organic light emitting diodes (OLED), and so on, but not limited thereto. Further, the display 210 may be implemented as a flexible display, a transparent display, and so on, according to circumstances.

The communicator 220 may communicate with the user terminal device 100, 100′. Specifically, the communicator 220 may communicate with the user terminal device 100, 100′ with a variety of communication methods described above.

Specifically, the communicator 220 may receive from the user terminal device 100, 100′ the signals corresponding to a variety of user interactions inputted through the user interface 120.

Further, the communicator 220 may transmit the content displayed on the display 210 to the user terminal device 100, 100′ according to a preset event.

The storage 230 stores various data such as operating system (O/S) software module for driving the display device 200, various multimedia content, various applications, various contents inputted or set during execution of the application, and so on. Specifically, since the storage 230 may be implemented in a similar form as the storage of the user terminal device 100′ as illustrated in FIG. 3, this will not be redundantly described in detail.

The controller 240 functions to control the overall operations of the display device 200.

The controller 240 may control the operation state, or more particularly, display state of the display device 200, according to a control signal received from the user terminal device 100. As described above, the signal received from the user terminal device 100 may be in the form of a signal corresponding to the user interaction state, or a control signal that is converted from a signal corresponding to the touch interaction state of the user to control the display device 200. When the signal received from the user terminal device 100 is a signal corresponding to the touch interaction of the user, the controller 240 may convert the corresponding signal into a control signal to control the display device 200.

Specifically, when a control signal is received from the user terminal device 100, requesting transmission of content, the controller 240 may transmit the displayed content to the user terminal device 100. In this example, the control signal may be received when a touch interaction is inputted in the dragging direction mapped with the display device 200.

For example, when a downward drag signal is received from the user terminal device 100, or when a content transmission request signal generated according to the downward drag manipulation is received, the controller 240 may transmit the displayed content to the user terminal device 100. In this example, the controller 240 may transmit the displayed content as streams to the user terminal device 100, or transmit to the user terminal device 100 the information (e.g., channel information of broadcast content, link information for web content, and so on) to receive the displayed content from the user terminal device 100 and display the same. When the user terminal device 100 receives the content information, the controller 240 may tune to a corresponding channel according to the corresponding content information, or access the link address and display the corresponding content.

Further, the controller 240 may control the display state of the UI screen that may be in various forms such as a channel zapping screen, a volume adjustment screen, various menu screen, webpage screen, and so on, according to a signal received from the user terminal device 100.

Further, depending on circumstances, the controller 240 may receive various contents from an external server (not illustrated). For example, when the user terminal device 100 provides an SNS screen according to user's instruction, the information of the corresponding screen may be received from the external server (not illustrated).

Hereinbelow, various embodiments of the present disclosure will be described with reference to the drawings.

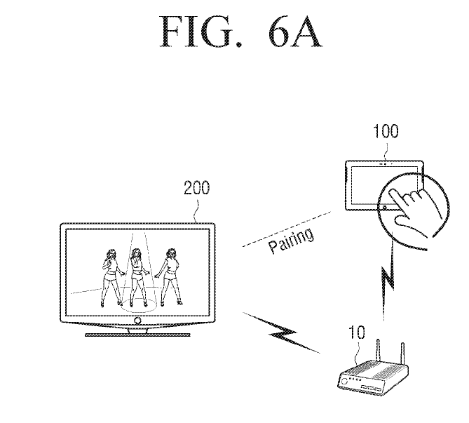

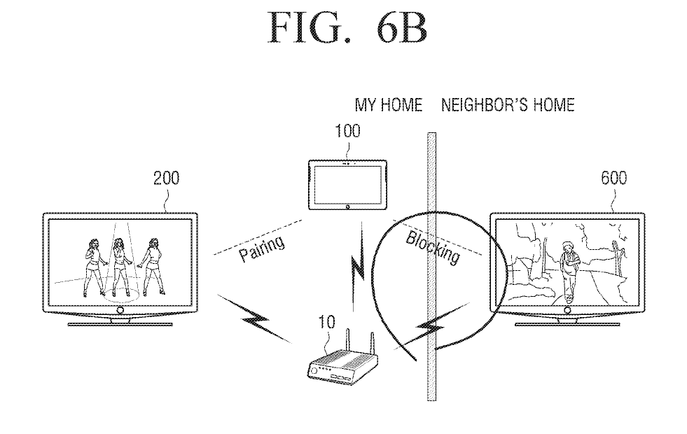

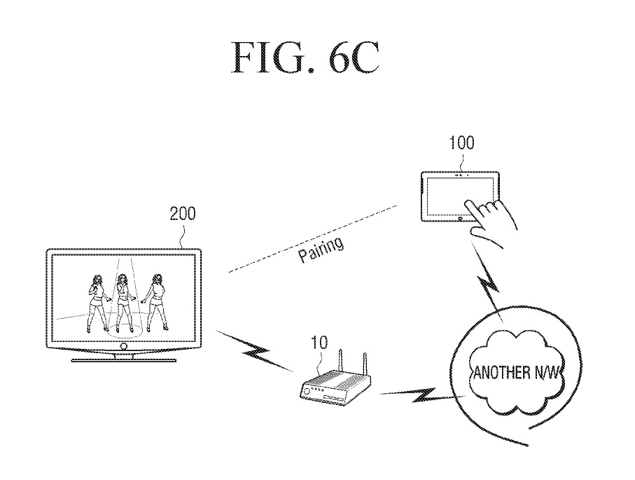

FIGS. 5a and 5b, and 6a to 6c are views provided to describe a method of pairing between a display device and a user terminal device according to an embodiment of the present disclosure.

As illustrated in FIG. 5a, the user terminal device 100 and the display device 200 may be connected via an access point device 10 for wireless communications. For example, the AP device 10 may be implemented as a wireless router that delivers wireless fidelity (Wi-Fi) signals. Note that, depending on circumstances, the Wi-Fi direct, which is the new P2P concept-based Wi-Fi technology, may be used to directly connect the Wi-Fi terminals, i.e., without using the wireless router.

Meanwhile, as illustrated, a set-top box 510 equipped with the communication terminal function for home use, which is necessary in order to use the next-generation two-way multimedia communication service (so-called interactive television) such as VOD content, image version home shopping, network games, and so on may be connected to the display device 200. The set-top box herein refers to a device that makes a TV an internet user interface, and a special computer that can actually transmit and receive the data via the internet. This is also equipped with web browser, and a protocol such as TCP/IP, and so on. The recent set-top box can service through a telephone line or a line for cable TV use, and so on, to provide the web TV services, and is equipped with the function of receiving and converting image signals, as a basic function.

As illustrated in FIG. 5b, the user terminal device 100 transmits Wi-Fi data (\textcircled{1}) to the display device 200. In this example, a display device 200 from the same manufacturer may perceive the same, but general universal AP may not be able to perceive, but discard the same. In such example, the need for changing H/W Chipset may be reduced, by defining a new data type using Wi-Fi standard format. Accordingly, the chipset company may provide only the API for the new data format, and the new data format may be independently defined by the manufacturer and kept as the confidential information. Meanwhile, the Wi-Fi data is a Wi-Fi signal that can penetrate the walls and be transmitted to the TVs in the neighborhood, but this can be distinguished for pairing.

The display device 200 then transmits the response data (\textcircled{2}) to the Wi-Fi data to the user terminal device 100. Specifically, upon perceiving the Wi-Fi data, the display device 200 responds with its current AP connection information. In this example, the responding to the targets not intended for connection may be limited, by using additional technology that allows communication only in a limited space/distance, such as ultrasound, IR or NFC.

As an alternative to \textcircled{2}, data (\textcircled{3}) for requesting connection information may be transmitted. In this example, the current AP connection information of the nearby TVs from the same manufacturer may be requested using additional technology such as ultrasonic, IR or NFC technology, immediately after the Wi-Fi data (\textcircled{1}). Upon perceiving the data (\textcircled{1}), the display device 200 waists for the request data (\textcircled{3}), and the connection information request data delivered with the additional technology that allows communication only in the limited space/distance is limited from being delivered to the TVs not intended for connection.

As an alternative to \textcircled{2}, response data (\textcircled{4}) to the connection information request may be transmitted. Because the AP connection information is delivered using Wi-Fi, and because the connection information request data (\textcircled{3}) is delivered only to the TVs intended for connection, upon perceiving the data (\textcircled{3}), the display device 200 may respond through the general Wi-Fi. Note that, when ultrasound is used, the example \textcircled{2} needs to use TV SPK, and therefore, the output range of SPK may be important, and in the case of \textcircled{3} and \textcircled{4}, there may be limitation that the TV should have Mic.

The AP connection request data (\textcircled{5}) is then transmitted. In this example, because the current AP connection information is acquired from the display device 200 intended for connection, the information may be utilized for requesting connection to a corresponding AP.

According to a pairing method described above, pairing may be performed with the minimized user intervention, as illustrated in FIG. 6a. For example, pairing may be performed just with Power on. That is, when the display device 200 is the first one that is On, when the user terminal device 100 is turned On, the N/W information within the existent display device 200 may be obtained such that the N/W is connected, and the pairing with the display device 200 is enabled, without requiring any additional operations. The opposite example is also possible. Further, once paired, the devices do not need to perform pairing again.

Further, as illustrated in FIG. 6b, pairing may be performed by distinguishing targets intended for connection and targets not intended for connection. For example, the devices not intended for pairing (e.g., neighbor's TV) may be distinguished and blocked.

Further, as illustrated in FIG. 6c, the limits on N/W environment may be minimized. For example, pairing may be performed even when other N/W is involved in the middle.

Further, although not illustrated in the drawings, depending on circumstances, use of additional technology such as IR/ultrasonic/NFC technologies may be contemplated in order to deliver, or to be delivered with the N/W information and so on that is previously connected within the device intended for pairing.

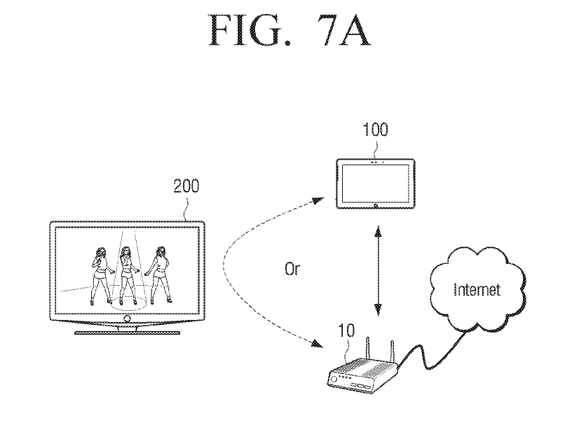

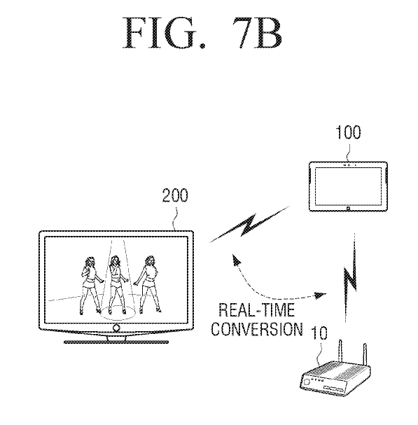

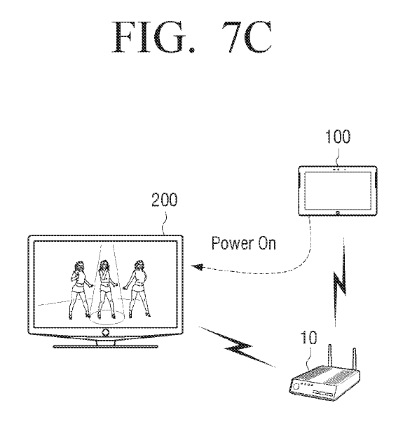

FIGS. 7a to 7c are views provided to describe a method of implementing network topology according to an embodiment of the present disclosure.

According to FIG. 7a, constant connectibility to the internet by the AP device 10 or the display device 200 may be ensured. In this example, the presence or the absence of the display device 200 and the AP device 10, or the connection state to the internet may determine the connection environment. That is, internet connectibility may be enabled in any cases.

According to FIG. 7b, the network topology may be modified into a variety of forms according to service scenarios. For example, when the display device 200 is transmitting images in real-time basis to the user terminal device 100, the display device 200 and the user terminal device 100 may be directly connected in P2P manner. In this example, modification of the network topology occurs rapidly so as not to allow latency issue to rise due to service modification.

According to FIG. 7c, Power On/Off control may be enabled using Wi-Fi. For example, the user terminal device 100 will have to Power On the TV 100 from Power Off state through Wi-Fi, or in the opposite example, Power Off the TV 100.

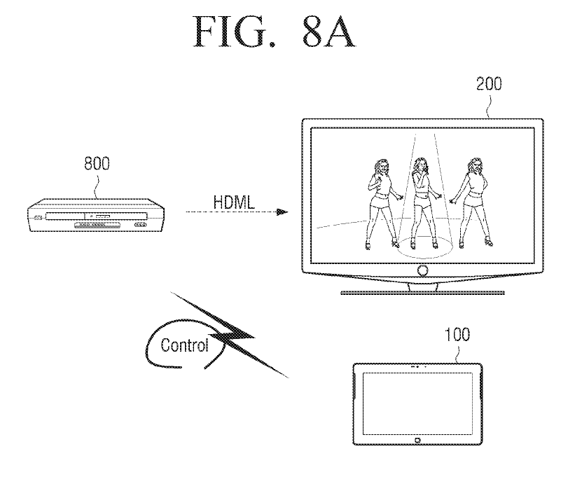

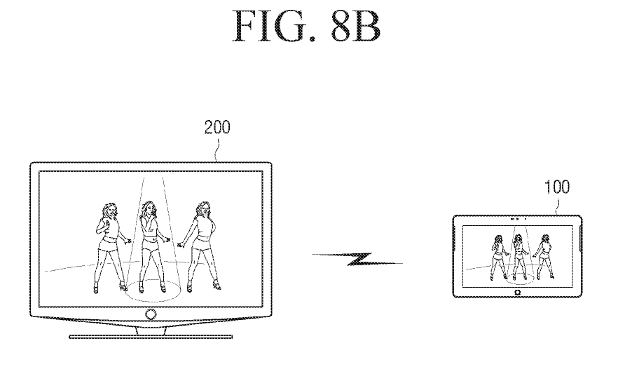

FIGS. 8a and 8b are views provided to describe a method of implementing a network topology according to another embodiment of the present disclosure.

As illustrated in FIG. 8a, the user terminal device 100 may be implemented to be able to control an external device such as STB remotely, through a gateway server within the display device 200. Further, an integrated remote control may be set without having setup, to thus control the external device such as STB.

As illustrated in FIG. 8b, the display device 200 and the user terminal device 100 may provide a variety of contents streams including push and view, drag and view, multi-angle view, and so on.

Hereinbelow, various embodiments of the present disclosure will be described based on assumption that the user terminal device 100 and the display device 200 are communicating in synchronization with each other as described above.

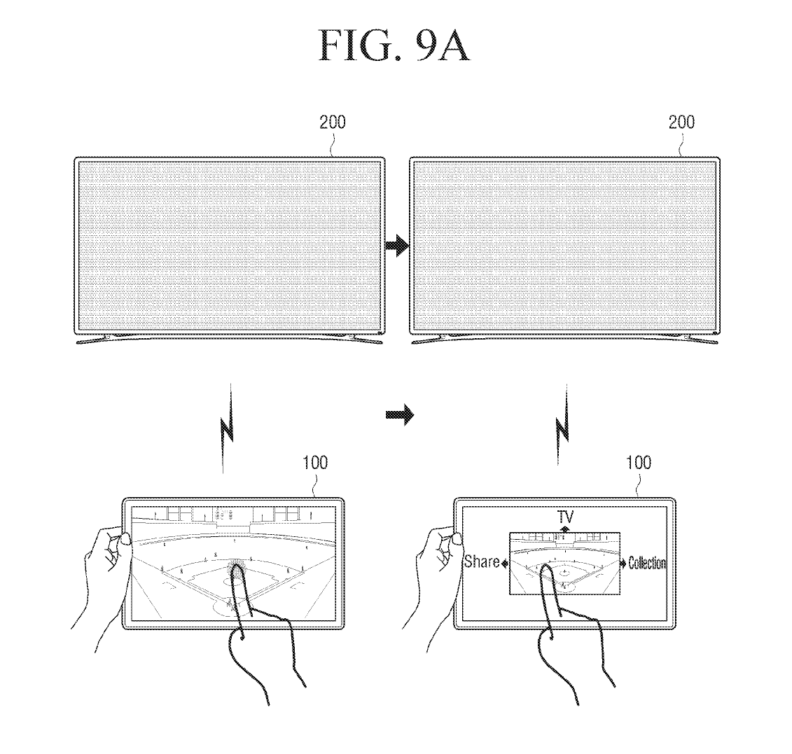

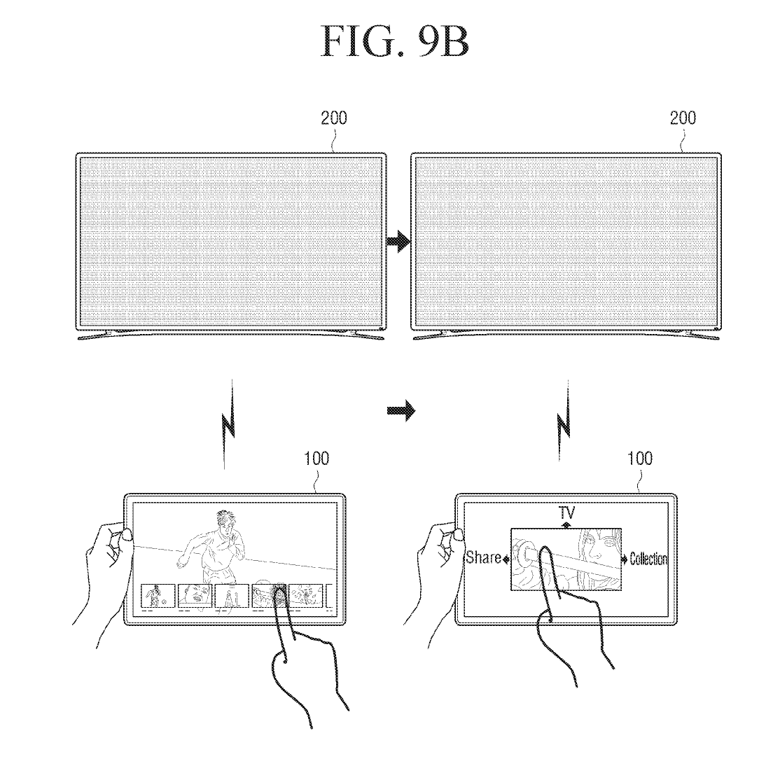

FIGS. 9a and 9b are views provided to describe a control method of a user terminal device according to an embodiment of the present disclosure.

As illustrated in FIGS. 9a and 9b, the user terminal device 100 may enter the content sharing mode according to a preset event. The preset event herein may be a preset touch interaction (e.g., an interaction of long-pressing an arbitrary region on a touch screen), but not limited thereto. For example, the content sharing mode may be entered in response to a variety of previously defined user interactions on the user terminal device 100 such as a touch interaction of pinching-in screen, a preset motion, or voices.

Specifically, as illustrated in FIG. 9a, while the content is being displayed on the entire screen of the user terminal device 100, when a touch interaction of long-pressing an arbitrary region on the screen is inputted, the screen may be displayed in a reduced size and the content sharing mode may be entered. In this example, the outer region of the reduced screen may provide the information of the targets for content sharing that corresponds to each of the directions. For example, information may be displayed, indicating that content may be shared with the TV according to upward interaction, that the content may be shared with the external server such as SNS according to the leftward interaction, that the displayed content may be shared with the content record service (e.g., favorites, my content collection) according to rightward interaction, and so on. The content record service herein refers to a service that stores (or bookmarks) the favorite content and information of the favorite content, in which the favorite content itself may be stored at a specific storage region, or the information of the favorite content alone may be stored (or bookmarked) and managed. In this example, the content itself may be stored and managed in at least one of the user terminal device 100, the display device 200, or other external server (content source server or content management server).

Further, as illustrated in FIG. 9b, when a touch interaction of long-pressing a thumbnail region displayed on the screen of the user terminal device 100 is inputted, the content sharing mode may be entered to share the content corresponding to the thumbnail. For example, as illustrated, while the selected thumbnail is being enlarged and displayed, the information on the targets for content sharing according to each direction may be provided on the outer region of the screen that is enlarged as illustrated in FIG. 9a.

Meanwhile, whether the screen of the display device 200 (e.g., TV) is OFF (as shown), or ON may not matter. For example, when the screen of the display device 200 is OFF, the user terminal device 100 may enter the content sharing mode, or the screen of the display device 200 may be turned ON according to the user's instruction to transmit the content to the display device 200 in the content sharing mode. Alternatively, depending on circumstances, the display device 200 may be required to be in a preset mode, i.e., in the content sharing mode, but this may be modified variously according to embodiments.

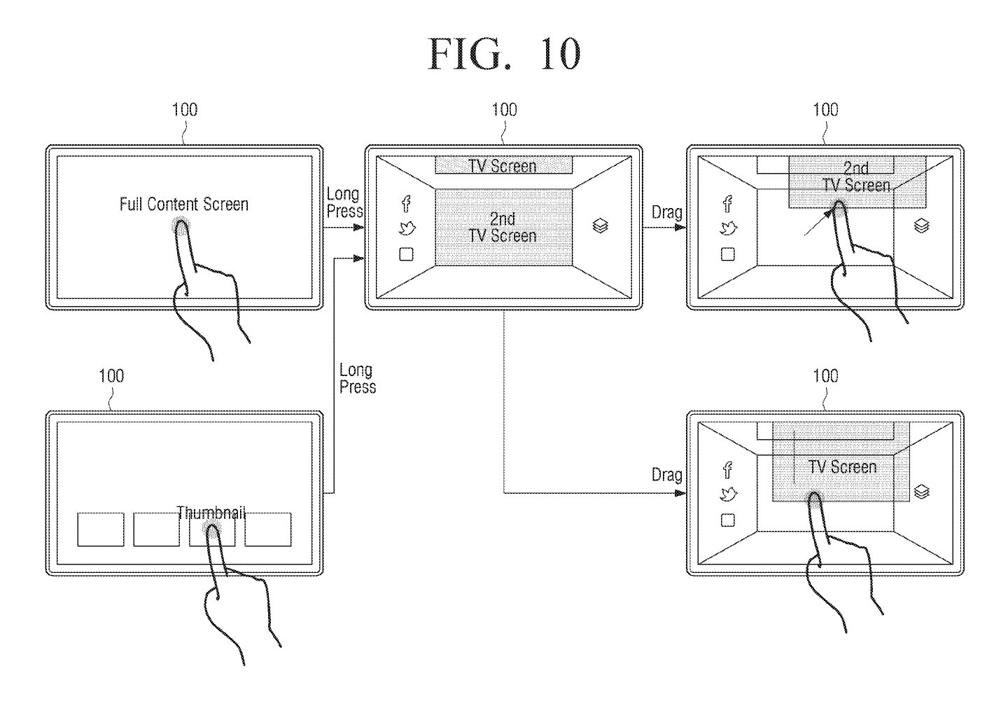

FIG. 10 is a view illustrates the content sharing mode according to an embodiment of the present disclosure for description purpose.

As illustrated in FIG. 10, while the content is being displayed on the entire screen (i.e., full content screen), in response to an input of long press manipulation for an arbitrary region, or long press manipulation for thumbnail content, sharing mode to share the corresponding content is entered.

In this example, the full content screen is reduced and the thumbnail content region is enlarged such that the screen is converted into a screen having a preset size, and the outer region of the corresponding screen may be divided into a plurality of region, e.g., into regions corresponding to each of the corners to provide identification information such as corresponding external device, service, and so on. For example, an upper region may provide a portion of the screen of the content displayed on TV, a left region may provide icon information corresponding to SNS server, and a right region may provide icon information corresponding to the content record service. The content record service has already been described above and will not be redundantly described below.

Then, when a user interaction of touch-and-dragging a corresponding content screen and moving the same to one of a plurality of regions, the corresponding content may be transmitted to an external device corresponding to the region to which the corresponding content is moved. For example, as illustrated, when the corresponding content screen is dragged to the upward direction, the corresponding content may be transmitted to TV, or when the TV screen provided on the upper side is dragged to the center of the screen, the content displayed on TV may be received at the user terminal device 100.

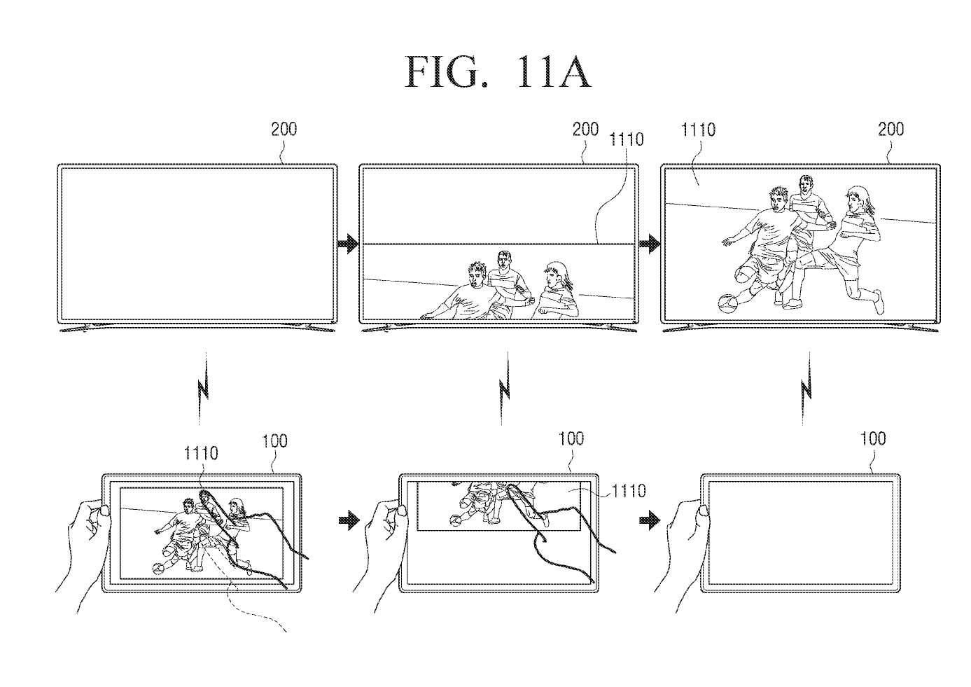

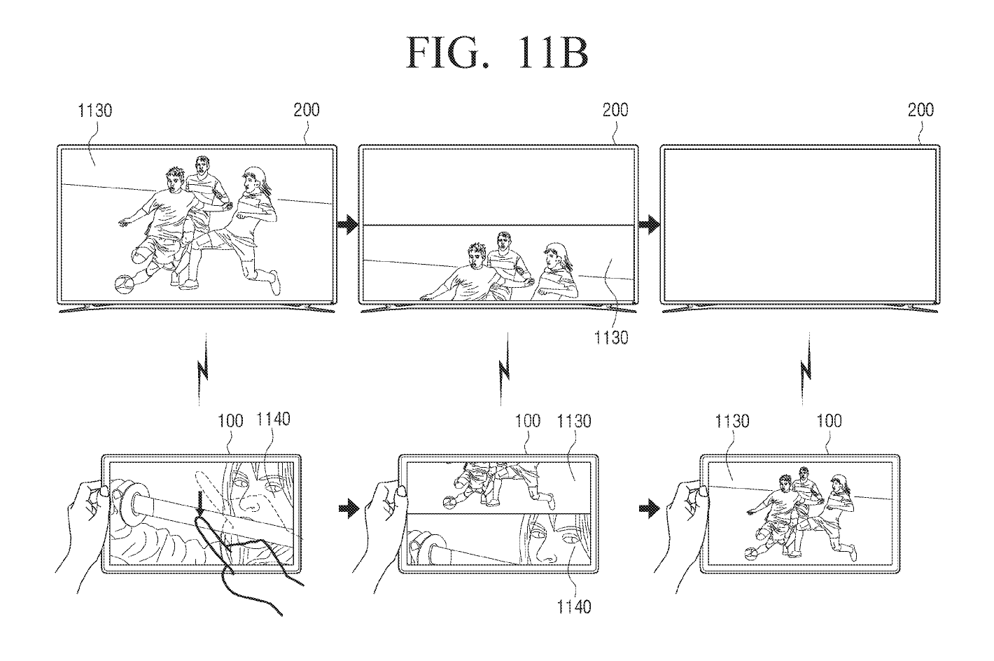

FIGS. 11a and 11b are views provided to describe a control method of a user terminal device according to another embodiment of the present disclosure.

As illustrated in FIG. 11a, while the user terminal device 100 is being in the content sharing mode, in response to a touch interaction of dragging in an upward direction, the displayed content 1110 may be transmitted to the display device 200 that corresponds to the dragging direction of the touch interaction.

In this example, the content displayed on the user terminal device 100, and the content transmitted to the display device 200 may be seamlessly connected during the transmission process, and displayed. For example, as illustrated, the content displayed on the user terminal device 100 may be moved, by sliding, to the upper side in accordance with the location (or velocity) of dragging by the user, and the content region moved to the upper side and disappeared from the screen of the user terminal device 100 may be seamlessly connected on the screen of the display device 200 and displayed.

Then the content 1110 may disappear from the screen of the user terminal device 100 and displayed on the screen of the display device 200.

As illustrated in FIG. 11b, it is assumed that the first content 1130 is displayed on the screen of the display device 200, and the second content 1140 is displayed on the screen of the user terminal device 100.

In response to input of a touch interaction of dragging in a downward direction on the screen of the user terminal device 100, the first content 1130 displayed on the display device 200 may be transmitted to the user terminal device 100.

In this example, as illustrated, the first content displayed on the display device 200, and the content transmitted to the user terminal device 200 may be seamlessly connected during transmission process, and displayed. For example, as illustrated, the second content 1140 displayed on the user terminal device 100 may be moved, by sliding, to a lower side in accordance with the location (or velocity) of dragging by the user, and the first content 1130 transmitted from the display device 200 may be moved downward, in a sliding manner, to the upper region of the screen and displayed. In this example, the first content region transmitted to the user terminal device 100 may also be moved by sliding in the display device 200 to the lower side and disappear from the screen. As a result, the first content 1130 transmitted from the display device 200 to the user terminal device 100 may be seamlessly connected on the screen of the display device 200 and displayed.

The content 1130 may then disappear from the screen of the display device 200, and displayed on the screen of the user terminal device 100.

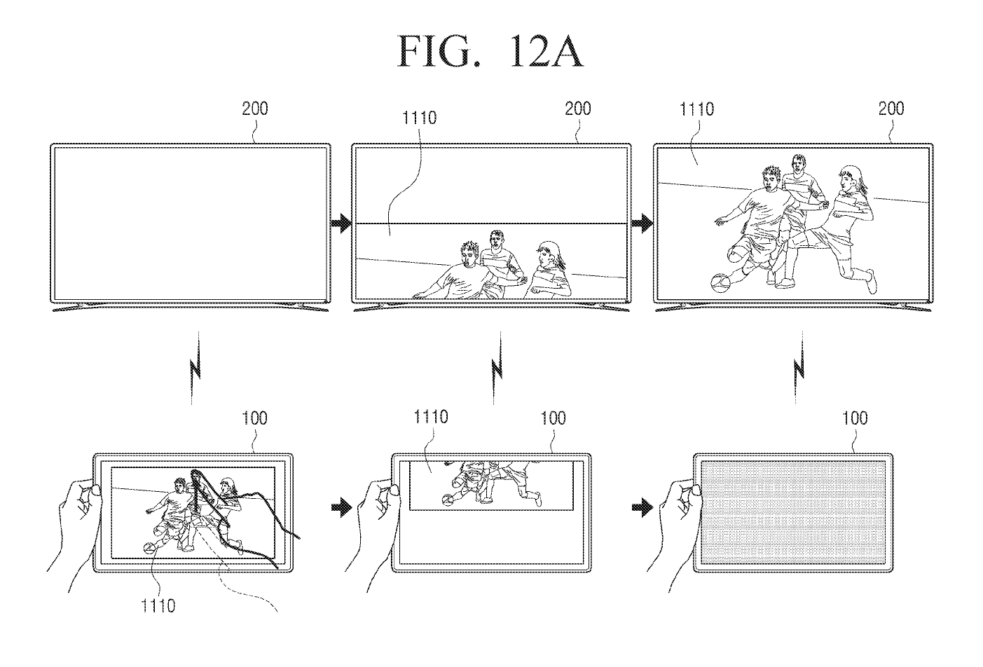

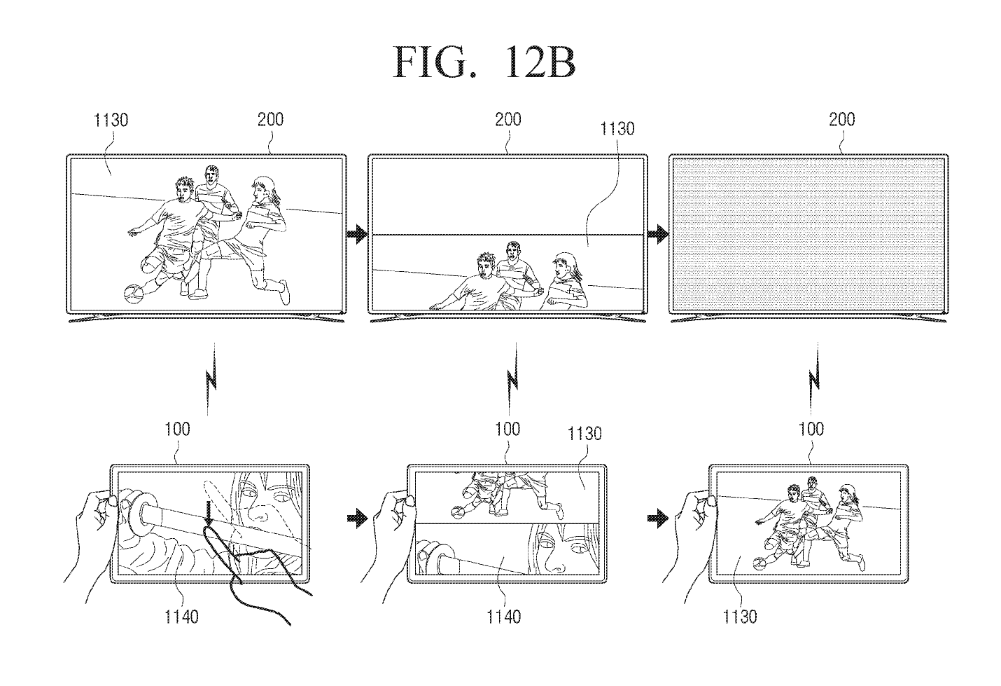

FIGS. 12a and 12b are views provided to describe a control method of a user terminal device according to another embodiment of the present disclosure.

As illustrated in FIG. 11a, FIG. 12a illustrates an example in which the displayed content 1110 is transmitted to the display device 200 in response to a touch interaction of dragging in an upward direction on the user terminal device 100, to the display device 200 in a direction corresponding to the dragging direction of the touch interaction. In this example, when the transmission of the content is completed as illustrated, the screen of the user terminal device 100 may be automatically turned OFF.

As illustrated in FIG. 11b, FIG. 12b illustrates an example in which the content 1130 displayed on the display device 200 is transmitted to the user terminal device 100 in response to a touch interaction of dragging in a downward direction on the user terminal device 100. In this example, when the transmission of the content is completed as illustrated, the screen of the display device 200 may be automatically turned OFF.

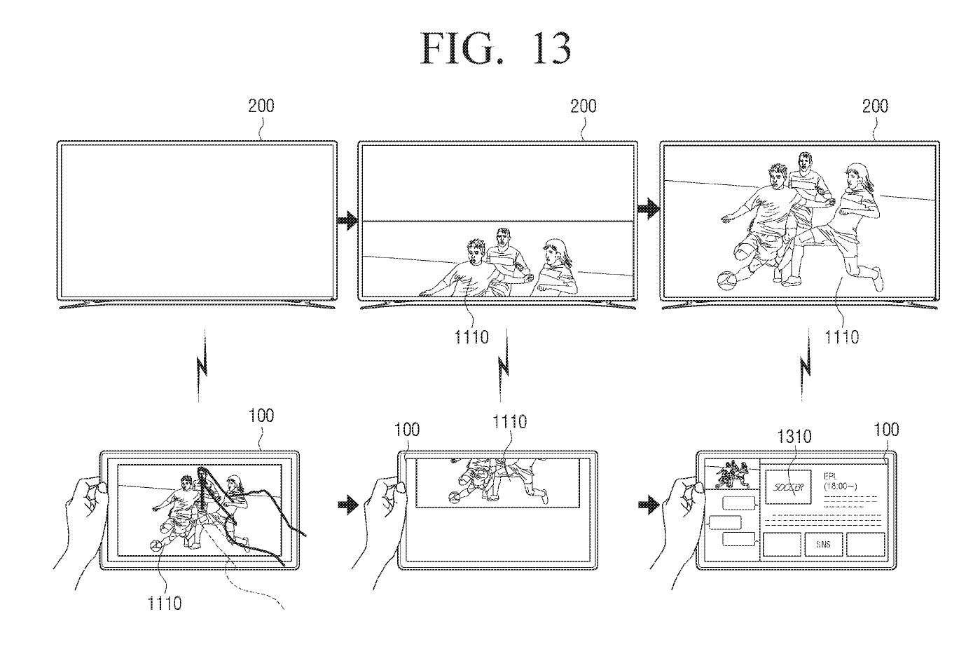

FIG. 13 is a view provided to describe a control method of a user terminal device according to yet another embodiment of the present disclosure.

As illustrated in FIG. 11a, FIG. 13 illustrates an example in which the displayed content 1110 is transmitted to the display device 200 in response to a touch interaction of dragging in an upward direction on the user terminal device 100, to the display device 200 in a direction corresponding to the dragging direction of the touch interaction. In this example, when the transmission of the content is completed as illustrated, associated information 1310 of the transmitted content 1110 may be displayed on the user terminal device 100. For example, when the transmitted content 1110 is a sport broadcast image, the sports broadcast information may be provided on the screen. The associated information may include a variety of information such as various associated information and social feeds, content detailed information, and so on, and may be updated in a real-time basis.

As a result, the user is able to check desired information without being interrupted with his or her viewing of the played content, by a simple touch interaction only.

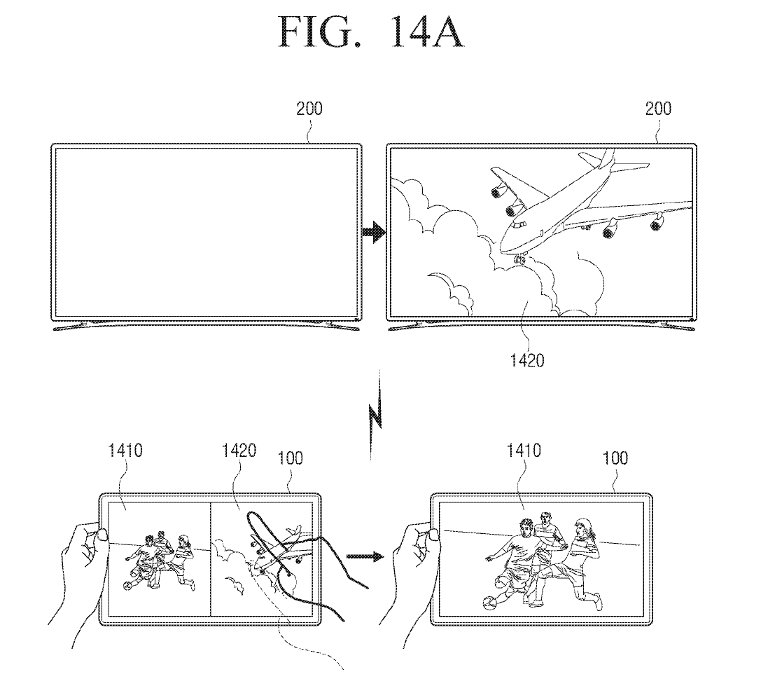

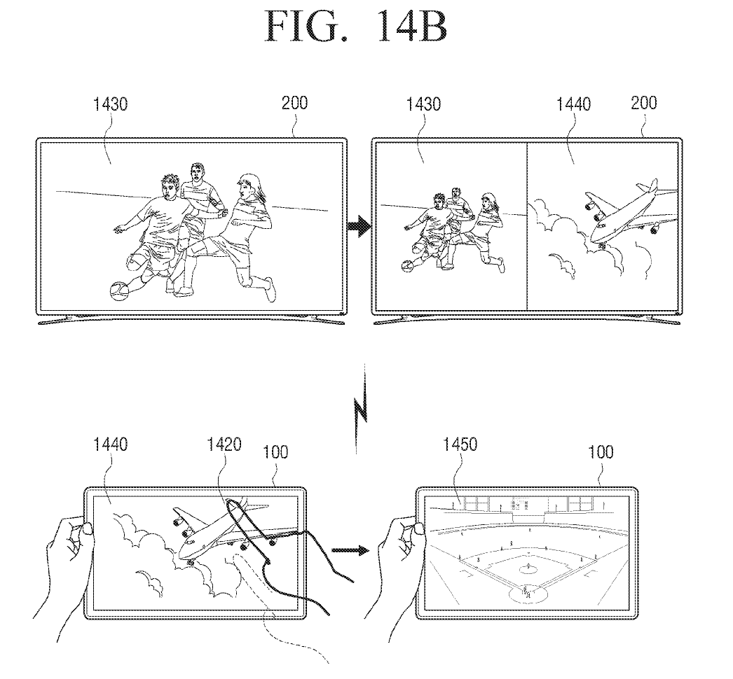

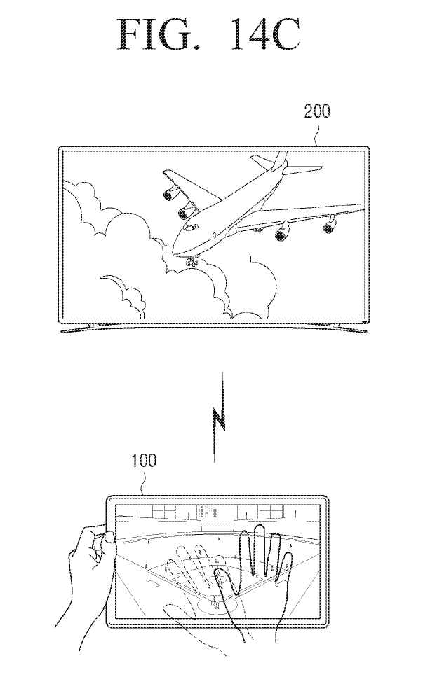

FIGS. 14a to 14c are views provided to describe a control method of a user terminal device according to yet another embodiment of the present disclosure.

As illustrated in FIG. 14a, it is assumed that the screen of the user terminal device 100 is divided into a plurality of regions, i.e., first and second regions and display first and second contents 1410, 1420 different from each other.

In this example, in response to a touch interaction of touching the screen of the second content 1420 and dragging in an upward direction, the second content 1420 displayed on the second region may be transmitted to the display device 200 and displayed on the screen of the display device 200. In this example, the first content 1410 displayed on the first region of the user terminal device 100 may be displayed on the entire screen of the user terminal device 100.

As illustrated in FIG. 14b, it is assumed that the first content 1430 is displayed on the display device 200, and the second content 1440 is displayed on the user terminal device 100.

In this example, in response to a touch interaction of touching the screen of the user terminal device 200 and dragging in an upward direction, the second content 1440 may be transmitted to the display device 200, and the screen of the display device 200 may be divided into a plurality of regions. In this example, the first region may display the first content 1430 that was originally displayed, and the second region may display the second content 1440 transmitted from the user terminal device 100. In this example, a preset third content may be displayed on the screen of the user terminal device 100, but not limited thereto.

FIG. 14c is provided to describe a method of sharing content with a control method other than touch interactions, and as illustrated, the content displayed on the user terminal device 100 may be transmitted to the display device 200 in response to a user's motion instead of touch interaction. In this example, the user's motion may be a palm motion that the user swipes his or her palm in a direction corresponding to the display device 200, but not limited thereto. Accordingly, motion such as flicking, panning, and so on may also be applied.

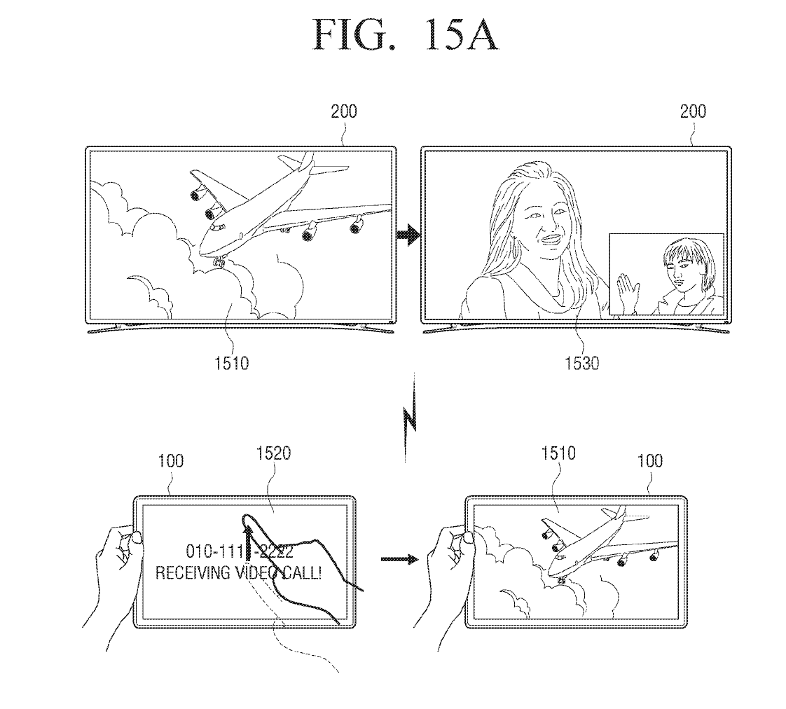

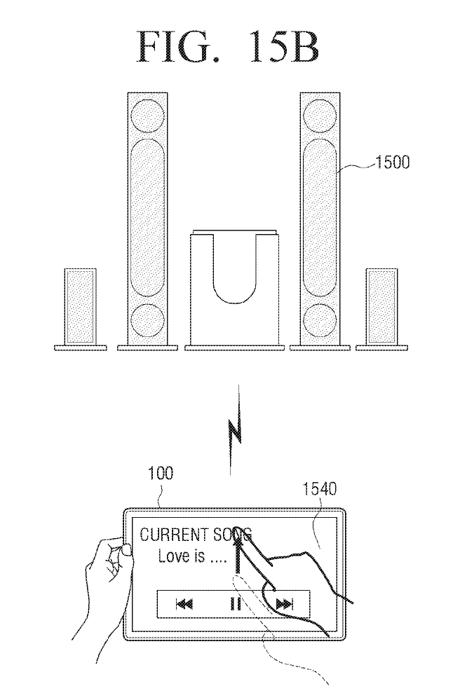

FIGS. 15a and 15b are views provided to describe a control method of a user terminal device according to yet another embodiment of the present disclosure.

As illustrated in FIG. 15a, it is assumed that a video phone call is received, while the content 1510 is being viewed through the display device 200.

In this example, in response to a touch interaction of dragging in an upward direction on the telephone reception screen 1520, the video telephone call may be connected on the display deice 200, and the video telephone screen 1530 may be displayed. In this example, the content 1510 displayed on the display device 200 may be transmitted to the user terminal device 100 and displayed, although not limited thereto.

FIG. 15b is provided to describe an example of controlling electronic device other than the display device 200, and it is assumed that the music is being played on the user terminal device 100.

In this example, in response to a touch interaction of dragging in a direction corresponding to the audio system 1500, the music being played on the user terminal device 100 may be transmitted to the audio system 1500 and played.

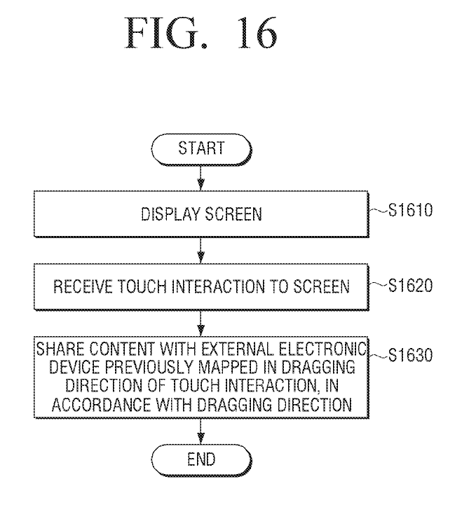

FIG. 16 is a flowchart provided to describe a control method of a user terminal device according to an embodiment of the present disclosure.

According to the control method of the user terminal device illustrated in FIG. 16, first, communication with the external electronic device is performed, at S1610.

At S1620, when a touch interaction is inputted to the screen, at S1630, content is shared with the external electronic device previously mapped in a finger movement direction of the touch interaction is shared, in accordance with the finger movement direction.

Further, the operation at S1630 of sharing the content may transmit the content displayed on the screen to the external electronic device previously mapped in the finger movement direction and share the content displayed on the screen with the external electronic device.

Further, when the external electronic device is being in turn-off state, the operation at S1630 of sharing the content may transmit a control signal to turn-on the external electronic device to the external electronic device.

Further, the control method of the user terminal device may additionally include a step of, when the content displayed on the screen is transmitted to the external electronic device and displayed, providing associated information of the content transmitted onto the screen.

Further, the operation at S1630 of sharing the content may allow the content displayed on the screen, and the content transmitted to the external electronic device and displayed to be seamlessly connected according to the dragging direction, and displayed.

Further, the operation at S1630 of sharing the content may receive the content displayed on the screen from the external electronic device previously mapped in the dragging direction of the touch interaction, and share the content with the external electronic device.

Further, the operation at S1630 of sharing the content may transmit the displayed content to the external electronic device when the touch interaction is an interaction of dragging in the upward direction of the screen, and receive the displayed content from the external electronic device when the touch interaction is an interaction of dragging in the downward direction of the screen.

Further, the operation at S1630 of sharing the content may transit the displayed content to SNS server, when the touch interaction is an interaction of dragging to one of leftward and rightward directions of the screen.

Further, the method may additionally include a step of entering the content sharing mode, reducing the screen, and displaying the same, in response to a preset touch interaction with respect to one region on the screen.

Further, in the step of reducing the screen and displaying the same, the outer region of the reduced screen may be divided into a plurality of regions, and each of the divided regions may provide the corresponding information about the external electronic device.

In this example, in response to a user interaction of touching the information about the external electronic device provided in each of the divided regions, and dragging it to the center region of the screen, the operation at S1630 of sharing the content may receive the content displayed on the corresponding external electronic device and display the same, and in response to a user interaction of touching the center region of the screen and dragging to the region where the information about the external electronic device provided in each of the divided region is displayed, may transmit the content displayed on the screen to the corresponding external electronic device.

As described above, according to the present disclosure, user convenience is enhanced, since content can be shared in a variety of manners with a simple touch interaction.

Meanwhile, the embodiments described above illustrate that the display device performs a variety of operations, but as noted above, the variety of operations at the display device may also be performed on a server or a user terminal device communicating with the display device.

Meanwhile, the display device, the user terminal device, and the control method of the server according to various embodiments of the present disclosure described above may be implemented as computer-executable program codes and stored in a non-transitory computer readable medium and provided to each of the devices in the stored state to be executed by the processor.

For example, a non-transitory computer readable medium storing therein a program to perform the step of performing communication with the external electronic device the step of inputting touch interaction to the screen, and the step of sharing content with the external electronic device previously mapped in the dragging direction, may be provided.

The non-transitory computer readable medium refers to a medium capable of storing data semi-permanently and is readable by the devices, rather than the medium such as register, cache, or memory that stores the data for a brief period of time. Specifically, various applications and programs described above may be stored on a non-transitory compute readable medium such as CD, DVD, hard disk, blu-ray disk, USB, memory card, ROM, and so on, and provided.

Further, the foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

What is claimed is:

1. A user terminal device, comprising:
a communicator configured to perform communication with an external electronic device;
a display device configured to display a screen;
a user interface configured to receive an input of a touch interaction to the screen; and
a controller configured to share a content with an external electronic device previously mapped in a finger movement direction of the touch interaction, in accordance with the finger movement direction.

2. The user terminal device of claim 1, wherein the controller transmits the content displayed on the screen to the external electronic device previously mapped in the finger movement direction and shares the content displayed on the screen with the external electronic device.

3. The user terminal device of claim 2, wherein, when the external electronic device is in turn-off state, the controller transmits a control signal to turn-on the external electronic device to the external electronic device.

4. The user terminal device of claim 2, wherein, when the content displayed on the screen is transmitted to the external electronic device and displayed, the controller provides associated information of the transmitted content on the screen.

5. The user terminal device of claim 2, wherein the controller controls such that the content displayed on the screen and the content transmitted to the external electronic device and displayed are seamlessly connected according to the dragging direction and displayed.

6. The user terminal device of claim 1, wherein the controller receives the content displayed on the screen from the external electronic device previously mapped in the dragging direction of the touch interaction, and shares the content with the external electronic device.

7. The user terminal device of claim 1, wherein, when the touch interaction is an interaction of dragging in an upward direction of the screen, the controller transmits the displayed content to the external electronic device, and when the touch interaction is an interaction of dragging in a downward direction of the screen, the controller receives the displayed content from the external electronic device.

8. The user terminal device of claim 1, wherein, when the touch interaction is an interaction of dragging to one of leftward and rightward directions of the screen, the controller transmits the displayed content to an SNS server.

9. The user terminal device of claim 1, wherein, when the touch interaction is an interaction of dragging to one of leftward and rightward directions of the screen, the controller stores the displayed content to a previously defined storage region.

10. The user terminal device of claim 1, wherein the control enters a content sharing mode in response to a preset touch interaction to one region on the screen, reduces the screen and displays the same.

11. The user terminal device of claim 10, wherein the controller divides an outer region of the reduced screen into a plurality of regions, and provides information about an external electronic device corresponding to each of the divided regions.

12. The user terminal device of claim 11, wherein, in response to a user interaction of touching the information about the external electronic device provided in each of the divided regions and dragging to a center region of the screen, the controller receives the content displayed on a corresponding external electronic device and displays the received content.

13. The user terminal device of claim 11, wherein, in response to a user interaction of touching a center region of the screen and dragging to a region where the information about the external electronic device provided in each of the divided regions is displayed, the controller transmits the content displayed on the screen to the corresponding external electronic device.

14. The user terminal device of claim 1, controlling such that a content receiving device is turned on, or a content transmitting device is turned off, in accordance with a dragging direction of the touch interaction.

15. A control method of a user terminal device, comprising:
performing communication with an external electronic device;
inputting a touch interaction to a screen; and
in accordance with a finger movement direction of the touch interaction, sharing the content with an external electronic device previously mapped in the finger movement direction.
